(19) United States
(12) Patent Application Publication
(10) Pub. No.: US 2021/0110182 A1
(43) Pub. Date: Apr. 15, 2021

(54) Electronic device and method for generating an alert signal, associated transport system and computer program

(71) Applicant: TRANSDEV GROUP INNOVATION, Issy-les-Moulineaux (FR)

(72) Inventors: Thomas DARNAUD, Versailles (FR); Cem KARAOGUZ, Guyancourt (FR)

(73) Assignee: TRANSDEV GROUP INNOVATION, Issy-les-Moulineaux (FR)

(21) Appl. No.: 17/069,886

(22) Filed: Oct. 14, 2020

(30) Foreign Application Priority Data
Oct. 15, 2019 (FR) 1911471

(51) Int. Cl. G06K 9/00; B60W 50/14

(52) U.S. Cl. CPC G06K 9/00832; G06K 9/00201; B60W 2540/01; B60W 50/14; G06K 9/00355

(57) ABSTRACT

The invention relates to an electronic device for generating an alert signal in a vehicle comprising:
an identification module designed to identify at least two items of information from two different categories from at least one image from an image sensor, each category being chosen from: the presence of an animal or an object prohibited and/or abandoned by one of the passengers; a characteristic movement or posture of one of the passengers and the presence of a furnishing element of the vehicle;
a detection module designed to detect an incident from the combination of two items of information from two different categories and from a warning rule associating the two items of information with said incident; and
a generation module designed to generate an alert signal when an incident is detected.

### CROSS-REFERENCE TO RELATED APPLICATIONS

This application is a U.S. non-provisional application claiming the benefit of French Application No. 19 11471, filed on Oct. 15, 2019, which is incorporated herein by reference in its entirety.

### FIELD OF THE INVENTION

The present invention relates to an electronic device for generating an alert signal, the device being suitable for being installed in a motor vehicle, in particular an autonomous vehicle.

The invention also relates to a transport system comprising a set of vehicles, a set of bus stops and an external monitoring platform.

The invention also relates to a method for generating an alert signal in a vehicle, in particular an autonomous vehicle, the method being implemented by such a device.

The invention also relates to a non-transitory computer-readable medium including a computer program comprising software instructions which, when executed by a computer, implement such a generation method.

The invention relates to the field of autonomous motor vehicles, in particular autonomous motor vehicles having a level of automation greater than or equal to 3 according to the scale of the International Organization of Automobile Manufacturers (IOAM).

In particular, the invention relates to the field of public transport, the vehicle being, in particular, a bus.

### BACKGROUND

As is known, when a bus is driven at least partially by a driver, the latter can react in the event of incidents taking place in the bus. For example, if a bus passenger smokes inside the bus, the driver will ask that passenger to put out his cigarette. As another example, in the event of an assault on a passenger by another passenger, the driver may call an organization in charge of maintaining order to intervene in the bus.

However, the handling of these incidents taking place in the vehicle may be further improved, especially in the absence of a driver.

### SUMMARY

The object of the invention is, therefore, to provide an electronic generation device making it possible to further improve the processing of such incidents taking place in the vehicle.

To this end, the invention relates to an electronic device for generating an alert signal, the device being suitable for being carried on board a vehicle, in particular an autonomous vehicle, the vehicle defining an interior space designed to receive a set of passengers, the device comprising: an identification module designed to identify at least two items of information from two different categories from at least one image from at least one image sensor on board the vehicle, each category being chosen from among the group consisting of: the presence of an animal and/or a prohibited object abandoned by one of the passengers; a characteristic movement or posture of one of the passengers; or the presence of a vehicle furnishing element; a detection module designed to detect an incident from the combination of said at least two items of information from two different categories and from a warning rule associating said at least two items of information with said incident; and a generation module designed to generate at least one warning signal upon detection of an incident by the detection module.

Thus, with the electronic generation device according to the invention, the identification module makes it possible to identify at least two items of information from two different categories in the vehicle, then the detection module makes it possible to detect an incident from these at least two items of information and a warning rule. The generation module is used to generate an alert signal if an incident is detected.

The electronic generation device according to the invention thus makes it possible to generate a relevant warning signal intended for passengers of the vehicle and/or an external monitoring platform. In particular, taking into account at least two items of information and the warning rule allows precise detection of the incident, especially in the event of incivility. This is particularly advantageous when the vehicle is an autonomous vehicle due to the absence of a driver who may communicate with passengers or with the exterior of the vehicle.

According to other advantageous aspects of the invention, the electronic generation device comprises one or more of the following characteristics, taken in isolation or in any technically feasible combination:
the prohibited object is chosen from the group consisting of: a weapon; a paper cigarette; an electronic cigarette; a pipe; a lighter; a portable speaker; scissors; a cutter; a felt-tip pen; a paint spray; a bike; food; a stroller; a package or a piece of luggage having a maximum dimension greater than a predetermined threshold;
the characteristic movement or posture of one of the passengers may be chosen from among the set of passengers consisting of: an extension of the passenger's arm for a time interval less than a predetermined threshold interval; repeated movement of the passenger's hand towards the mouth of said passenger; a movement of the passenger's hand towards a furnishing element of the vehicle; a movement of the passenger's hand towards another passenger; a seated position with the passenger's leg extended onto another seat; and a closed first of the passenger;
the furnishing element of the vehicle may be chosen from among the group consisting of: a door; a seat; a window; a display screen; a speaker; a camera; an air conditioning diffuser; a handle or a grab bar; a transport ticket validator; an intercom; a handle for unlocking the vehicle doors; an emergency stop button; first-aid equipment; vehicle floor marking or a computer USB port;
for two items of information relating to the presence of a prohibited object and to the movement of one of the passengers, the warning rule is suitable for associating said at least two items of information for the detection of a respective incident if the passenger is in possession of the prohibited object and if the passenger's movement involves movement of the prohibited object;
for two items of information relating to the presence of a prohibited object or of an animal and to the presence of a furnishing element of the vehicle, the warning rule is suitable for associating said at least two items of information for the detection of a respective incident if the prohibited object or the animal or the furnishing element is moved by a distance less than a predetermined threshold distance;
for two items of information relating to the characteristic movement or posture of one of the passengers and the presence of a furnishing element of the vehicle, the warning rule is suitable for associating the at least two items of information for the detection of a respective incident if the passenger is in contact with the furnishing element;
the detection module is designed to detect each incident from at least a single image and from at least one series of images during a predetermined period of time corresponding to the incident;
the device comprises a processing module designed to receive the warning signal and to send, depending on the warning signal, a request for assistance to an external vehicle monitoring platform and/or a command chosen from the group consisting of: sound command to a loudspeaker located in the interior space or on an external wall of the vehicle; visual command on a display screen located in the interior space or on an external vehicle wall; an emergency stop control to an on-board braking system; a locking command for a vehicle door; a vehicle movement command; a vehicle speed variation command or a command to send an alert signal to an organization in charge of maintaining order; while
the processing module is designed to send the command or the request for assistance as a function of a level of probability of detection of the incident calculated by the device and/or of a predetermined level of criticality associated with the incident identified by the device.

Another object of the invention is an autonomous vehicle defining an interior space designed to receive a set of passengers, the vehicle comprising such an electronic generation device and at least one on-board image sensor connected to the electronic generation device, the electronic generation device being as defined above.

An object of the invention is also a transport system comprising:
a set of vehicles, at least one vehicle being a vehicle comprising a first electronic device for generating an alert signal, the first device being according to any one of the preceding claims and at least one image sensor connected to the electronic generation device;
a set of bus stops, each bus stop being suitable for receiving passengers waiting for one of the vehicles;
an external monitoring platform designed to monitor said set of vehicles and said set of bus stops;
at least one of the bus stops comprising a second electronic device for generating an alert signal, the second device comprising:
   a second identification module designed to identify at least two items of information from two different categories from at least one image from a second image sensor attached to the bus stop, each category being chosen from among the group consisting of: the presence of a prohibited object or an animal in the bus stop; a characteristic movement or posture of one of the passengers; and the presence of a second furnishing element at the bus stop;
   a second detection module designed to detect an incident taking place at the bus stop from the combination of said at least two items of information from two different categories and from a warning rule associating said at least two items of information about the incident; and
   a second generation module designed to generate at least one warning signal in the event of detection of an incident by the second detection module.

Another object of the invention is a method for generating an alert signal in a vehicle, in particular an autonomous vehicle, the method being implemented by an electronic generation device, the vehicle comprising an interior space designed to receive a set of passengers, the method comprising the following steps:
identification of at least two items of information from two different categories from at least one image from an image sensor on board the vehicle, each category being chosen from among the group consisting of: the presence of ‘a prohibited object or animal; a characteristic movement or posture of one of the passengers; and the presence of a vehicle furnishing element;
detection of an incident from the combination of said at least two items of information from two different categories and from a warning rule associating said at least two items of information with said incident; and
generation of at least one warning signal in the event of detection of an incident.

Another object of the invention is a non-transitory computer-readable medium including a computer program comprising software instructions which, when executed by a computer, implement a generation method as defined above.

### BRIEF DESCRIPTION OF THE DRAWINGS

These characteristics and advantages of the invention will emerge more clearly upon reading the description which follows, given solely by way of non-limiting example, and made with reference to the accompanying drawings, in which:

FIG. 1 is a schematic representation of a transport system according to the invention;

FIG. 2 is a longitudinal vertical sectional view of a vehicle according to the invention of the transport system of FIG. 1;

FIG. 3 is a schematic representation of an electronic generation device on board the vehicle of FIG. 2;

FIG. 4 is a schematic representation of a second electronic generation device disposed at a bus stop of the transport system of FIG. 1; and

FIG. 5 is a flowchart of a method, according to the invention, for generating an alert signal in the vehicle of FIG. 2.

### DETAILED DESCRIPTION

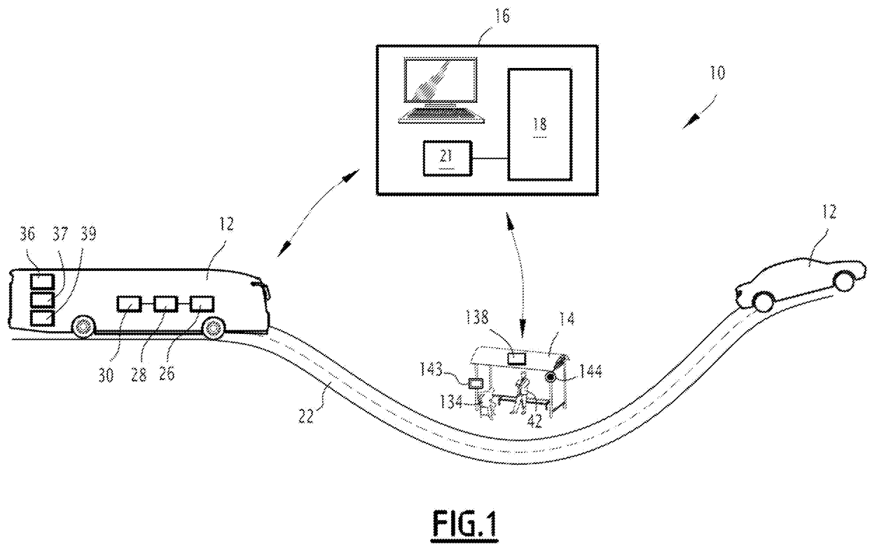

A transport system 10 is shown in FIG. 1. The transport system 10 includes a set of vehicles 12, a set of bus stops 14, an external platform 16 for monitoring said vehicles 12 and said bus stops 14.

The external monitoring platform 16 is designed to monitor said set of vehicles 12 and said set of bus stops 14.

To this end, the external monitoring platform 16 comprises an electronic device 18 for monitoring vehicles 12 and bus stops 14. In addition, the external monitoring platform 16 comprises a display screen 20 and input/output means 21, such as a keyboard and a mouse, each being connected to the electronic monitoring device 18.

Each vehicle 12 is, for example, a motor vehicle, in particular a bus, designed to move on a traffic lane 22.

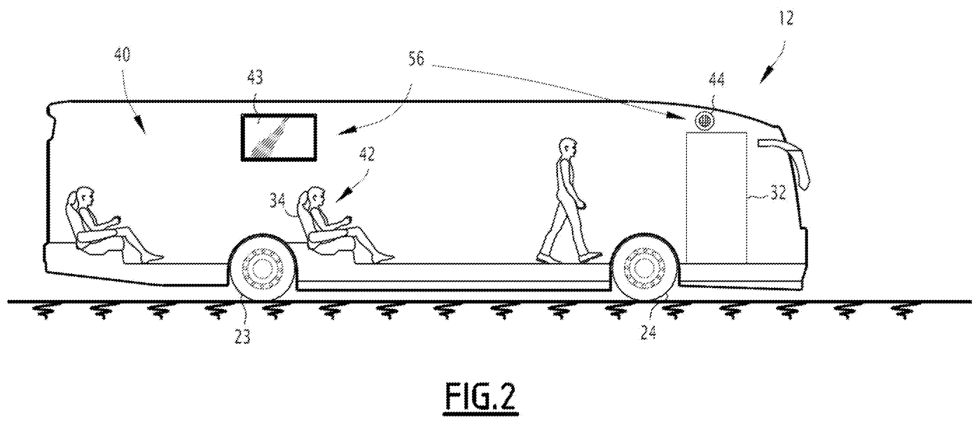

As may be seen in FIGS. 1 and 2, each vehicle 12 comprises, in a known manner, rear wheels 23, front wheels 24, a motor 26 mechanically connected via a transmission chain (not shown) to the rear 23 and/or front wheels 24 for driving said wheels 23, 24 in rotation about their axes, a steering system (not shown), designed to act on the wheels 23 and/or 24 of the vehicle 12 so as to modify the orientation of their trajectory, and a braking system (not shown), designed to exert a braking force on the wheels 23, 24 of the vehicle 12.

Each motor vehicle 12 is typically constituted by a vehicle with traction and/or electric propulsion. To this end, the motor 26 is in the form of an electric motor, while the vehicle 12 comprises an electric battery (not shown) that is electrically connected to the motor 26 for supplying the motor 26 with electricity.

Each motor vehicle 12 is, for example, an autonomous vehicle. To this end, the motor vehicle 12 comprises an electronic autonomous driving device 28 designed to control the vehicle autonomously by receiving information on the environment of the vehicle 12 via at least one sensor 30, also called an environment sensor, and, by acting on the motor 26, the steering system and the braking system, so as to modify the speed, acceleration and trajectory of the vehicle 12 based on the information received. Each environment sensor 30 is, for example, a camera, a temperature sensor, a pressure sensor, a humidity sensor or a lidar.

Each autonomous motor vehicle 12 preferably has an automation level greater than or equal to 3 according to the scale of the International Organization of Automobile Manufacturers (IOAM). The level of automation is then equal to 3, i.e. conditional automation, or equal to 4, i.e. high automation, or equal to 5, i.e. full automation.

According to the IOAM scale, level 3 of conditional automation corresponds to a level for which the driver does not need to constantly monitor dynamic driving, nor the driving environment, while still having to be able to regain control of the autonomous motor vehicle 12. According to this level 3, an autonomous driving management system, on board the autonomous motor vehicle 12, then performs longitudinal and lateral driving control in a defined case of use and is suitable to recognize its performance limits and then require the driver to resume dynamic driving within a sufficient margin of time.

High automation level 4 corresponds to a level where the driver is not required in a defined case of use. According to this level 4, the autonomous driving management system on board the autonomous motor vehicle 12, then performs the lateral and longitudinal dynamic driving control in all the situations of this defined use case.

Level 5 of full automation finally corresponds to a level for which the autonomous driving management system on board the autonomous motor vehicle 12, performs dynamic lateral and longitudinal driving control in all the situations encountered by the autonomous motor vehicle 12 throughout its journey. No driver is then required.

As visible in FIG. 2, the vehicle 12 advantageously further comprises at least one door 32, at least one seat 34, at least one image sensor 36, advantageously an additional sensor 37 and an electronic generation device 38 to generate a signal inside the vehicle 12.

The vehicle 12 has an interior space 40 designed to receive a set of passengers 42, and, advantageously, goods to be transported.

The term “passenger” is understood to mean a passenger located in the interior space 40 of the vehicle, a person located outside the vehicle 12 waiting to be able to board the vehicle or a person located outside the vehicle 12 having traveled on board the vehicle 12.

The vehicle 12 further advantageously comprises at least one display screen 43 and at least one loudspeaker 44.

The display screen 43 and the loudspeaker 44 are advantageously arranged in the interior space 40. Alternatively, or in addition, the display screen 43 and the loudspeaker 44 may be arranged on an external wall of the vehicle.

Each screen 43 and each loudspeaker 44 are able to communicate at least one item of information to the passenger(s) 42 present in the vehicle 12 or outside it.

The interior space 40 communicates with the exterior of the vehicle 12 at least through the door 32. The door 32 is designed to allow passengers 42 and/or goods to pass from the outside to the inside of the interior space 40, and vice versa. The interior space 40 is delimited, in particular, by a floor, on which the passengers 42 and the goods move/are moved inside the interior space 40. The door 32 is, in particular, a side door defining a transverse opening extending vertically from the floor.

Each seat 34 is suitable for receiving one of the passengers 42. In other words, each seat 34 is a place for a respective passenger 42. The seat 34 is, in particular, a sitting place such as, for example, a seat or a bench, or a standing place such as, for example, by a handle.

Each image sensor 36 is designed to provide at least one image of the interior and/or exterior of the vehicle 12.

The vehicle 12 advantageously comprises a plurality of image sensors 36.

Each additional sensor 37 is able to provide at least one piece of data relating to the interior and/or the exterior of the vehicle 12. Each additional sensor 37 is chosen from among the group consisting of: a presence sensor, a sound sensor, an infrared sensor, a weight sensor and a temperature sensor.

Each sensor 36, 37 is connected to the electronic generation device 38.

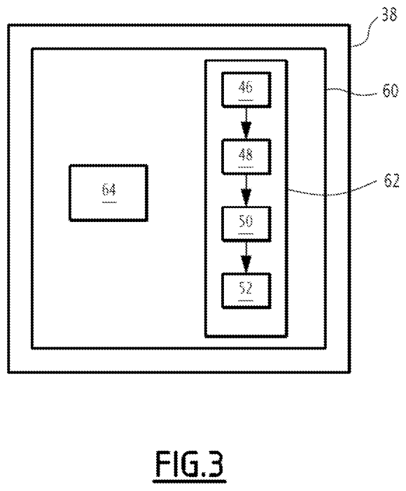

As visible in FIG. 3, the generation device 38 comprises an identification module 46, a detection module 48, a generation module 50 and, advantageously, a processing module 52.

The identification module 46 is designed to identify at least two items of information from two different categories from at least one image from the image sensor 36.

Each category is chosen from among the group consisting of:
the presence of an animal or an object that is prohibited and/or has been abandoned by one of the passengers 42;
a characteristic movement or posture of one of the passengers 42; and
the presence of a vehicle furnishing element 12.

The animal may be, for example, a dog accompanying, or not, one of the passengers 42.

The prohibited item is chosen from among the group consisting of: a weapon; a paper cigarette; an electronic cigarette; a pipe; a lighter; a portable speaker; a pair of scissors; a cutter; a felt-tip pen; a paint spray; a bike; food; a stroller; a package or luggage having a maximum dimension greater than a predetermined threshold.

The maximum dimension is, for example, greater than 50 cm.

Those skilled in the art will understand that by “prohibited object” is meant any object which may annoy passengers 42 of the vehicle 12 during their journey or which may damage the vehicle 12.

The characteristic movement or posture of one of the passengers 42 is chosen from among the group consisting of:
an extension of one arm of the passenger 42 for a time interval less than a predetermined threshold duration;
repeated movement of the passenger's hand 42 towards the mouth of said passenger 42;
a movement of the hand of the passenger 42 towards a furnishing element 56 of the vehicle 12;
a movement of the hand of the passenger 42 towards another passenger 42;
a sitting position with one leg extended by the passenger 42; and
a closed first of the passenger 42.

The threshold duration is, for example, less than 1 second.

The vehicle furnishing element 56 is selected from among the group consisting of: a door 32; a seat; a window; the display screen 43; the loudspeaker 44; a camera; an air conditioning diffuser; a handle or a grab bar; a transport ticket validator; an intercom; a handle for unlocking the doors 32 of the vehicle 12; an emergency stop button; first-aid equipment; vehicle floor marking and a computer USB port.

In an advantageous embodiment, the identification module 46 is designed to identify each piece of information by processing the image(s) coming from the image sensor(s) associated with a method of machine learning.

The machine learning method is based, for example, on a model using a statistical approach in order to improve the performance of this method in solving tasks, without being explicitly programmed for each of these tasks. Machine learning has two phases. The first phase consists in defining a model from data present in a database, called observations. The estimation of the model consists, in particular, in recognizing the presence of one or more objects in an image. This so-called learning phase is generally carried out prior to the practical use of the model. The second phase corresponds to the use of the model: the model being defined, new images are then submitted to the model, in order to obtain the object(s) detected on said images.

The machine learning model comprises, for example, the implementation of a neural network. A neural network is generally made up of a succession of layers, each of which takes its inputs from the outputs of the previous layer. Each layer is made up of a plurality of neurons, taking their input from neurons in the previous layer. A synaptic weight is associated with each synapse between neurons, so that the inputs received by a neuron are multiplied by this weight, then added by said neuron. The neural network is optimized by adjusting the different synaptic weights during the learning phase according to the images present in the initial database.

In an advantageous embodiment, the identification module 46 is designed to assign a level of reliability to each item of information identified. Advantageously, the identification module 46 is designed to consider the information only if the level of reliability is greater than a predetermined threshold.

The level of reliability is, for example, determined according to the reliability of the associated sensor 36, 37 and/or according to the reliability of the machine learning model used.

The reliability of a sensor 36, 37 is, for example, determined by measuring a margin of error in the measurements made by said sensor 36, 37.

The reliability of the identification model is, for example, determined from a success rate of detection of the information from the image database.

The detection module 48 is designed to detect an incident from the combination of said at least two items of information from two different categories identified by the identification module 46 and from a warning rule associating said at least two items of information with said incident information.

In particular, the incident detected is an incivility committed by a passenger 42 likely to interfere with the peace and/or comfort of other passengers 42 of the vehicle 12, or else likely to damage the vehicle 12.

By way of example, the detected incident is chosen from among the group consisting of:
damage to the vehicle 12 committed by one of the passengers 42;
an attack on the cleanliness of the vehicle 12 committed by one of the passengers 42;
the consumption of food or alcohol by one of the passengers 42 in the vehicle 12;
the presence in the vehicle 12 of one of the passengers 42 smoking;
impairment of the sound comfort of passengers 42;
physical and/or verbal threatening behavior by one of the passengers 42 towards at least one of the other passengers 42;
the presence of a weapon in the interior space 40;
the presence of a bulky and cumbersome object in the interior space 40;
the presence of an animal in the interior space 40;
an impediment by one of the passengers 42 to closing the door 32;
the presence of a package forgotten and/or trapped in the interior space 40;
an injury to one of the passengers 42; or
the discomfort and/or the fall of one of the passengers 42.

The warning rule is a predefined rule making it possible to associate the information identified by the identification module 46 and the incident detected by the detection module 48.

In particular, for two items of information relating to the presence of a prohibited object and to the movement of one of the passengers 42, the warning rule is suitable for associating said at least two items of information for the detection of a respective incident if the passenger 42 is in possession of the prohibited object and if the movement of a passenger 42 involves movement of the prohibited object.

By way of example, one of the warning rules associates the identification of a cigarette in the hand of one of the passengers 42 and the identification of the repeated movement of the hand of said passenger towards his mouth with the incident that there is the presence in the vehicle 12 of a passenger 42 smoking.

As another example, one of the warning rules combines the identification of a knife in the hand of one of the passengers 42 and the identification of the movement of the hand of the passenger 42 towards another. passenger 42 with the incident that there is physical and/or verbal threatening behavior by one of the passengers 42 towards at least one of the other passengers 42 in the vehicle 12.

Again by way of another example, one of the warning rules associates the identification of waste in the hand of one of the passengers 42 and the identification of an extension of an arm of the passenger. during a time interval less than the predetermined threshold duration of the incident, according to which there is a degradation of the vehicle 12 committed by one of the passengers 42 and, in particular, throwing away waste by the passenger 42 in the vehicle 12.

Alternatively or in addition, for two items of information relating to the presence of a prohibited object or of an animal and to the presence of a furnishing element of the vehicle, the warning rule is suitable for associating said at least two items of information for the detection of a respective incident if the prohibited object or the animal and the furnishing element are separated by a distance less than a predetermined threshold distance.

The predetermined threshold distance is, for example, less than 10 cm.

By way of example, one of the warning rules associates the identification of one of the doors 32 and the identification of an item of luggage having a maximum dimension greater than the predetermined threshold and located at a distance less than the predetermined threshold distance of said door 32, with the incident that there is the presence of a bulky and cumbersome object in the internal space 40 hindering the entry or exit of the vehicle 12.

As another example, one of the warning rules combines the identification of one of the display screens 43 and the identification of a spray can located at a distance less than the predetermined threshold distance of said screen 43 with the incident that there is a degradation of the vehicle 12 committed by one of the passengers 42 and, in particular, a degradation of the screen 43 by paint.

Again by way of another example, one of the warning rules associates the identification of one of the seats and the identification of food placed on said seat with the incident according to which there is consumption of food by one of the passengers 42 in the vehicle 12.

Again by way of another example, one of the warning rules combines identification of one of the seats and the identification of a cutter or a pen arranged on said seat with the incident according to which there is a degradation of the seat by means of the cutter or the pen by one of the passengers 42.

Alternatively or in addition, for two items of information relating to the characteristic movement or to the posture of one of the passengers 42 and the presence of a furnishing element 56 of the vehicle 12, the warning rule is suitable for associating the at least two items of information for the detection of a respective incident if the passenger is in contact with the furnishing element.

By way of example, one of the warning rules combines the identification of a seated position with an extended leg of the passenger 42 and the identification of one of the seats in contact with the foot of the passenger with the incident that there is an attack on the cleanliness of the vehicle 12 committed by one of the passengers 42 and, in particular, by the presence of a passenger 42 putting his feet on the seat.

As another example, one of the warning rules associates the identification of one of the doors 32 and the identification of a movement of the hand of one of the passengers 42 towards the door 32 with the incident according to which the passenger 42 prevents the closing of the doors 32.

Again by way of example, one of the warning rules associates the identification of a window or a screen of the vehicle 12 and the identification of a movement of the hand of one of the passengers 42 towards the window or the screen with the incident that the passenger 42 hits the window or the screen.

In an advantageous embodiment, the detection module 48 is designed to detect an incident from the combination of at least one item of information from each of the three different categories and from a warning rule associating said at least three items of information about the incident.

By way of example, one of the warning rules combines the identification of a felt-tip pen in the hand of one of the passengers 42, the identification of a repeated movement of said hand of the passenger 42 and the identification of a window or wall of the vehicle located at a distance from the felt-tip pen of less than the predetermined threshold distance with the incident according to which there is a degradation of the vehicle 12 committed by the passenger 42 and, in particular, the presence of a passenger 42 marking the window or wall with a felt-tip pen.

Alternatively or in addition, the detection module 48 is designed to detect an incident only when at least two warning rules have associated at least two items of information with the same incident.

Still further, the detection module 48 is designed to detect each incident from a single image from the image sensor(s) 36 and, further, from at least one series of images from the image sensor(s) 36 during a predetermined period of time corresponding to the incident.

By way of example, the detection module 48 is designed to detect the presence of a smoker on board the vehicle 12 in the event of identification of a cigarette in a single image and in the event of identification of the movement of the hand of the passenger 42 to his mouth in a succession of images corresponding to a time period of approximately 3 seconds.

By way of another example, the detection module 46 is designed to detect a degradation of one of the seats by a passenger 42 in the event of identification of a cutter or a pair of scissors in a single image and in the event of a identification of the repeated movement of the hand of the passenger 42 towards the seat in a succession of images corresponding to a time period of approximately 10 seconds.

Alternatively or in addition, the detection module 48 is designed to detect each incident from at least one image from the image sensor(s) 36 and from at least one item of information from an additional sensor 37.

In particular, the detection module 48 is designed to detect the incident in addition from sound data coming from a sound sensor on board the vehicle 12.

By way of example, the detection module 48 is designed to detect an attack on a passenger 42 by another passenger 42 in the event of identification of a weapon in an image and in the event of identification of a characteristic expression. such as “Help” or “SOS” in the sound data.

Alternatively or in addition, the detection module 48 is further designed, when the vehicle 12 is stationary at a bus stop 14, to detect an incident outside the vehicle 12 from the combination of at least two items of information from two different categories from among said categories and from a warning rule associating said at least two items of information with said incident.

By way of example, from the identification of one of the wheels 23, 24 and the identification of a knife or cutter in contact with said wheel 23, 24, the detection module 48 is designed to detect a degradation of the vehicle 12, and, in particular, the presence of an individual trying to puncture the tire of the wheel 23, 24 of the vehicle 12.

The generation module 50 is designed to generate at least one warning signal upon detection of an incident by the detection module 48. The generation module 50 is further designed to send the warning signal to the processing module 52.

In an advantageous embodiment, the generation module 50 is designed to calculate a level of probability of detection of the incident.

The probability level reflects the probability that said detected incident actually takes place in the vehicle 12. For example, a probability level of 100% indicates that the incident takes place with certainty.

The level of probability is determined, for example, according to the level of reliability of each item of information used for the detection of the incident.

The level of probability is also determined from the reliability of the associated warning rule. The reliability of the warning rule is, for example, determined from a success rate of detection of the incident from an information database.

Alternatively or in addition, the generation module 50 is further designed to assign a predetermined level of criticality associated with the incident.

The level of criticality of each incident is, for example, determined by the type of incident detected and by the severity of the incident detected. In particular, the more an incident is likely to affect the safety of the passengers 42 of the vehicle 12, the more the generation module 50 attributes to this incident a high level of criticality. For example, the detection of an assault on a passenger 42 has a higher criticality than the detection of waste being thrown in the vehicle 12.

The processing module 52 is designed to receive the warning signal generated by the generation module 50.

Depending on the warning signal, the processing module 52 is designed to send a request for assistance to the external monitoring platform 16.

The request for assistance advantageously comprises the images associated with the incident, so that the operator may display them on the display screen 20 of the external platform 16 and make a decision.

In particular, the processing module 52 is able to receive from the external platform 16 for monitoring the vehicle 12 an instruction chosen from the group consisting of:
an instruction to send the warning signal to an organization in charge of maintaining order;
an instruction to send the warning signal in the form of an audible signal to the loudspeaker 44 located in the interior space 40 or on an external wall of the vehicle 12;
an instruction to send the warning signal in the form of a visual signal to the display screen 43 located in the interior space 40 or on the external wall of the vehicle 12;
an instruction to send the warning signal in the form of an emergency stop signal to the vehicle's braking system 12;
a door locking instruction 32;
an instruction to vary the speed of the vehicle 12 to the electronic autonomous driving device 28; and
an instruction to move along a new trajectory to the electronic autonomous driving device 28.

In addition or alternatively, the processing module 52 is designed to send, as a function of the warning signal, a command chosen from the group consisting of:
an audio command to the loudspeaker 44 located in the interior space 40 or on the exterior wall of the vehicle 12;
a visual command on the display screen 43 located in the interior space 40 or on an external wall of the vehicle 12;
an emergency stop command to the vehicle braking system 12;
a door locking command 32;
a command to move the vehicle along a new trajectory to the electronic autonomous driving device 28;
a vehicle speed variation command 12 to the electronic autonomous driving device 28; and
a command to send the warning signal to an organization in charge of maintaining order.

Advantageously, the processing module 52 is designed to send the command or the request for assistance as a function of the level of probability of detection of the incident calculated by the generation module 50 and/or of the predetermined level of criticality associated with the incident assigned by the generation module 50.

In particular, the processing module 52 is designed to send the request to the external platform 16 when the detection probability level is less than a threshold probability, in order then to allow the operator to confirm the reality of the incident before making a decision.

The threshold probability is, for example, less than 75%.

In addition, the processing module 52 is designed to send the request to the external platform 16, when the level of criticality is greater than a threshold criticality in order to allow the operator to be able to act as effectively as possible with respect to the incident and to limit the consequences for passengers 42 of the incident.

By way of example, in the event of detection of a passenger 42 putting a foot on one of the seats, the processing module 52 is designed to send the sound command directly to the speaker 44 located next to said passenger 42 asking him to remove his foot from the seat.

Conversely, in the event of the detection of physical and/or verbal threatening behavior by one of the passengers 42, the processing module 52 is designed to preferentially send a request for assistance to the external monitoring platform 16, in order to be able to broadcast an appropriate message or notify the police if necessary.

Again, as an example, in the event of detection of alcohol consumption by one of the passengers 42 in the vehicle 12, the processing module 52 is designed to send the sound command to the speaker 44 located next to said passenger 42 asking him to stop his consumption and also to send a request for assistance to the external platform 16 in order to be able to check the intoxicated state of the passenger 42 and act accordingly.

In the example of FIG. 3, the generation device 38 comprises an information processing unit 60 formed, for example, by a memory 62 and of a processor 64 associated with the memory 62.

In the example of FIG. 3, the identification module 46, the detection module 48, the generation module 50 and the processing module 52 are each produced in the form of software, or of a software brick, executable by the processor 64. The memory 62 is then able to store identification software, detection software, generation software, and processing software. The processor 64 is then able to execute each of the software programs.

In a variant not shown, the identification module 46, the detection module 48, the generation module 50 and the processing module 52 are each made in the form of a programmable logic component, such as an FPGA (Field Programmable Gate Array), or in the form of a dedicated integrated circuit, such as an ASIC (Application Specific Integrated Circuit).

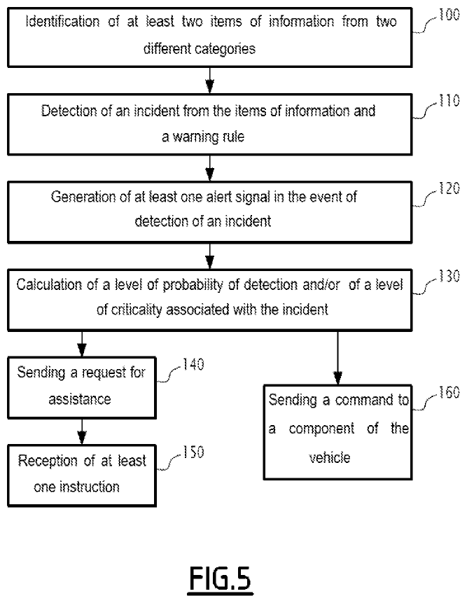

The operation of the electronic generation device 38 according to the invention will now be explained with the aid of FIG. 5 showing a flowchart of the method, according to the invention, for generating an alert signal in the vehicle 12, the method being implemented by the electronic generation device 38.

Initially, the vehicle 12 is traveling on the traffic lane 22 or is stopped at one of the bus stops 14.

The method comprises an initial step 100 of identifying at least two items of information from two different categories from at least one image from the image sensor(s) 36 on board the vehicle 12.

The method then comprises a step 110 of detecting an incident from the combination of said at least two items of information from two different categories and from the warning rule associating said at least two items of information with said incident.

Then, during a step 120, the generation module 50 generates at least one warning signal in the event of detection of an incident.

During an optional step 130, the generation module 50 calculates the level of probability of detection of the incident and/or the predetermined level of criticality associated with the incident.

Then, the method advantageously comprises a step 140 of sending a request for assistance to the external monitoring platform 16 of the vehicle 12.

Then, the method comprises a step 150 of receiving at least one instruction sent by the operator of the external monitoring platform 16 after he has observed the images associated with the detected incident.

As an alternative or in parallel with steps 140 and 150, the method comprises a step 160 of sending, as a function of the warning signal, a command to a component of the vehicle 12 as described above, or even to an organization in charge of maintaining order.

As is visible in FIG. 1, each bus stop 14 is suitable for receiving passengers 42 waiting for one of the vehicles 12.

In particular, each bus stop 14 is advantageously a specific bus stop to receive passengers 42 waiting for a bus.

Each bus stop 14 is an arrangement disposed, for example, on a sidewalk at the edge of the traffic lane 22.

The bus stop 14 includes, for example, a pole and an information device displaying the times and the route of said vehicle.

In addition or alternatively, as shown in FIG. 1, the bus stop 14 comprises at least one wall forming a shelter against bad weather for the passengers 42.

Advantageously, the bus stop 14 further comprises a second image sensor 136, a second additional sensor 137, a second display screen 143, a second loudspeaker 144 and at least a second furnishing element 156.

The second furnishing element 156 is, for example, a second seat 134 such as a seat or a bench.

In an advantageous embodiment, at least one of the bus stops 14 comprises a second electronic device 138 for generating an alert signal.

The second electronic generation device 138 is similar to the generation device 38 described above and the only differences between the two devices 38, 138 is described below.

In particular, the second generation device comprises a second identification module 146, a second detection module 148, a second generation module 150 and a second processing module 152.

The second identification module 146 is designed to identify at least two items of information from two different categories from at least one image from an image sensor attached to the bus stop 14.

Each category being chosen from the group consisting of:
the presence of a prohibited object or an animal at the bus stop 14;
a characteristic movement or posture of one of the passengers 42; and
the presence of a furnishing element at the bus stop 14.

The second detection module 148 is designed to detect an incident taking place at the bus stop 14 from the combination of said at least two items of information from two different categories and from a warning rule associating said at least two items of information about the incident.

In particular, the detected incident is an incivility committed by a passenger 42 likely to interfere with the peace and/or comfort of other passengers 42 waiting for the vehicle, or even likely to degrade the bus stop 14.

By way of example, the detected incident is chosen from the group consisting of:
a degradation of the bus stop 14 committed by one of the passengers 42;
an attack on the cleanliness of the bus stop 14 committed by one of the passengers 42;
impairment of the sound comfort of passengers 42;
physical and/or verbal threatening behavior by one of the passengers 42 towards at least one of the other passengers 42;
the presence of a weapon in bus stop 14;
the presence of a bulky and cumbersome object in the bus stop 14;
the presence of a package forgotten and/or trapped at the bus stop 14;
an injury to one of the passengers 42; and
the discomfort and/or the fall of one of the passengers 42.

The second generation module 150 is designed to generate at least one warning signal upon detection of an incident by the second detection module 148.

The second processing module 152 is designed to receive the warning signal.

Depending on the warning signal, the second processing module 152 is further designed to send a request for assistance to the external monitoring platform 16 of the bus stop 14.

The request for assistance advantageously includes the images associated with the incident so that the operator may display them on the display screen 20 of the external platform 16 and make a decision.

In particular, the second processing module 152 is able to receive from the external platform 16 for the monitoring of the bus stop 14, an instruction chosen from the group consisting of:
an instruction to send the warning signal to an organization in charge of maintaining order;
an instruction to send the warning signal in the form of an audible signal to the second loudspeaker 144 of the bus stop 14; and
an instruction to send the warning signal as a visual signal to the second display screen 143 at the bus stop 14

In addition or as alternatively, the second processing module 152 is designed to send, as a function of the warning signal, a command chosen from among the group consisting of:
a sound command to the second loudspeaker 143 of the bus stop 14;
a visual command on the second display screen 144 of bus stop 14; and
a command to send the alert signal to an organization in charge of maintaining order.

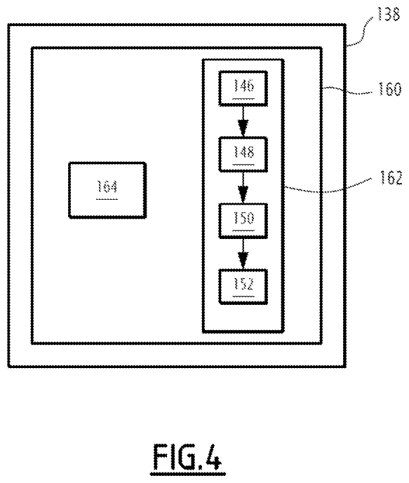

In the example of FIG. 4, the generation device 138 comprises a second information processing unit 160 formed, for example, by a second memory 162 and a second processor 164 associated with the second memory 162.

In the example of FIG. 4, the second identification module 146, the second detection module 148, the second generation module 150 and the second processing module 152 are each produced in the form of software, or of a software brick, executable by the second processor 164. The second memory 162 is then able to store identification software, detection software, generation software, and processing software. The second processor 164 is then able to execute each of the software programs.

In a variant not shown, the second identification module 146, the second detection module 148, the second generation module 150 and the second processing module 152 are each produced in the form of a programmable logic component, such as an FPGA. (Field Programmable Gate Array), or in the form of a dedicated integrated circuit, such as an ASIC (Application Specific Integrated Circuit).

The operation of the second electronic generation device 138 according to the invention is similar to the operation of the electronic generation device 38 described above and will not be described hereinafter.

It will thus be appreciated that the present invention offers a certain number of advantages.

The generation device 38 according to the invention improves the processing of incidents taking place in vehicles 12 and at bus stops 14 of transport system 10.

In fact, taking into account at least two items of information and the warning rule allows precise detection of the incident and, therefore, a more relevant reaction.

In particular, the use of information from two different categories makes it possible to obtain a more complete knowledge of what is happening in the vehicle 12 or at the bus stop 14 and, therefore, allows more precise detection of incidents.

In addition, the fact of combining different detection means, such as, for example, detection on a single image or on a succession of images, or even via an additional sensor 37, makes it possible to further increase this precision.

In addition, sending a command directly to a component of the vehicle 12 or at the bus stop 14, such as the loudspeaker 44, 144, allows a very rapid reaction and then limits the consequences for other passengers 42.

Sending a request for assistance to the external platform 16 makes it possible, in the event of uncertainty as to the accuracy or seriousness of the incident, to involve an operator who may act as effectively as possible according to the various items of information from the sensors 36, 37, 136, 137, without being physically present in the vehicle 12 or at the bus stop 14.

The invention therefore makes it possible to significantly improve the comfort for passengers 42 of the transport system 10, as well as their safety, by allowing rapid and efficient processing of incidents, in particular incivility, taking place in the vehicle 12 or at the bus stop 14.

All of these advantages are particularly interesting when the vehicle 12 is autonomous, in particular an autonomous bus, because the invention allows detection and rapid reaction in line with the reality of the situation, even in the absence of a driver in the vehicle 12.

1. An electronic device for generating an alert signal, the device being able to be carried on board a vehicle, in particular an autonomous vehicle, the vehicle defining an interior space designed to receive a set of passengers, the device comprising:
an identification module designed to identify at least two items of information from two different categories from at least one image from at least one image sensor on board the vehicle, each category being chosen from the group consisting of: the presence of an animal or an object that is prohibited and/or abandoned by one of the passengers; a characteristic movement or posture of one of the passengers; and the presence of a furnishing element of the vehicle;
a detection module designed to detect an incident from the combination of said at least two items of information from two different categories and from a warning rule associating said at least two items of information with said incident; and
a generation module designed to generate at least one warning signal in the incident upon detection of an incident by the detection module.

2. The device according to claim 1, wherein the prohibited object is selected from the group consisting of: a weapon; a paper cigarette; an electronic cigarette; a pipe; a lighter; a portable speaker; a pair of scissors; a cutter; a felt-tip pen; a paint spray; a bike; food; a stroller; a package or luggage having a maximum dimension greater than a predetermined threshold.

3. The device according to claim 1, wherein the characteristic movement or posture of one of the passengers is selected from the group consisting of: an extension of an arm of the passenger during a time interval less than a predetermined threshold duration; repeated movement of the passenger's hand towards the mouth of said passenger; movement of the passenger's hand towards a vehicle furnishing element; movement of the passenger's hand towards another passenger; a seated position with the passenger's leg extended; or a closed first of the passenger.

4. The device according to claim 1, wherein the furnishing element of the vehicle is selected from among the group consisting of: a door; a seat; a window; a display screen; a speaker; a camera; an air conditioning diffuser; a handle or a grab bar; a transport ticket validator; an intercom; a handle for unlocking the doors of the vehicle; an emergency stop button; first-aid equipment; a vehicle floor marking, or a computer USB port.

5. The device according to claim 1, wherein, for two items of information relating to the presence of a prohibited object and the movement of one of the passengers, the warning rule is specific in associating said at least two items of information for the detection of a respective incident if the passenger is in possession of the prohibited object and if the movement of the passenger involves the displacement of the prohibited object.

6. The device according to claim 1, wherein, for two items of information relating to the presence of a prohibited object or an animal and the presence of a furnishing element of the vehicle, the warning rule is suitable for associating said at least two items of information for the detection of a respective incident if the prohibited object or the animal and the furnishing element are at a distance less than a predetermined threshold distance.

7. The device according to claim 1, wherein, for two items of information relating to the characteristic movement or the posture of one of the passengers and the presence of a furnishing element of the vehicle, the warning rule is suitable for associating the at least two items of information for the detection of a respective incident if the passenger is in contact with the furnishing element.

8. The device according to claim 1, wherein the detection module is designed to detect each incident from at least one single image and, further, from at least one series of images during a predetermined period of time corresponding to the incident.

9. The device according to claim 1, wherein the device comprises a processing module designed to receive the warning signal and to send, depending on the warning signal, a request for assistance to an external platform monitoring the vehicle and/or a command chosen from the group consisting of: a sound command to a speaker located in the interior space or on an external wall of the vehicle; a visual command on a display screen located in the interior space or on an external vehicle wall; an emergency stop command to an on-board braking system; a door locking command of the vehicle; a command for moving the vehicle; a vehicle speed variation command and a command to send an alert signal to an organization in charge of maintaining order.

10. The device according to claim 9, wherein the processing module is designed to send the command or the request for assistance as a function of a level of probability of detection of the incident calculated by the device and/or a predetermined criticality level associated with the incident assigned by the device.

11. A transport system according to claim 1, comprising:
a set of vehicles, at least one vehicle being a vehicle comprising a first electronic device for generating an alert signal, the first device being at least one image sensor connected to the electronic generation device;
a set of bus stops, each bus stop being suitable for receiving passengers waiting for one of the vehicles;
an external monitoring platform designed to monitor said set of vehicles and said set of bus stops;
at least one of the bus stops comprising a second electronic device for generating an alert signal, the second device comprising:
a second identification module designed to identify at least two items of information from two different categories from at least one image from a second image sensor attached to the bus stop, each category being selected from the group consisting of: the presence of a prohibited object or animal at the bus stop; a characteristic movement or posture of one of the passengers; and the presence of a second furnishing element at the bus stop;
a second detection module designed to detect an incident taking place at the bus stop from the combination of said at least two items of information from two different categories and from warning a rule associating said at least two items of information with said incident; and
a second generation module designed to generate at least one warning signal in the event of detection of an incident by the second detection module.

12. A method of generating an alert signal in a vehicle, in particular an autonomous vehicle, the vehicle comprising an interior space designed to receive a set of passengers, the method being implemented by an electronic generation device and comprising the following steps:
identification of at least two items of information from two different categories from at least one image from an image sensor on board the vehicle, each category being chosen from the group consisting of: the presence of a prohibited object or an animal; a characteristic movement or posture of one of the passengers; and the presence of a furnishing element of the vehicle;
detection of an incident from the combination of said at least two items of information from two different categories and from a warning rule associating said at least two items of information with said incident; and
generation of at least one warning signal in the event of detection of an incident.

13. A non-transitory computer-readable medium including a computer program comprising software instructions which, when executed by a computer, implement a generation method according to claim 12.
